(19) United States
(12) Patent Application Publication
(10) Pub. No.: US 2020/0382691 A1
(43) Pub. Date: Dec. 3, 2020

(54) IMAGE PROCESSING AND SIGNAL TRANSMITTING DEVICE AND METHOD THEREOF, AND CAMERA LAMP SYSTEM

(71) Applicants: Inventec (Pudong) Technology Corporation, Shanghai (CN); INVENTEC CORPORATION, Taipei (TW)

(72) Inventor: Chen-Hsiang Shih, Taipei (TW)

(21) Appl. No.: 16/435,885

(22) Filed: Jun. 10, 2019

(30) Foreign Application Priority Data
May 28, 2019 (CN) 201910451418.7

(51) Int. Cl. H04N 5/232; H04N 5/225

(52) U.S. Cl. CPC H04N 5/23206; H04N 5/2256; H04N 5/23241

(57) ABSTRACT

An image processing and signal transmitting device comprises an Ethernet connection port, a magnetic circuit, a power transmission circuit, and a computing circuit. The Ethernet connection port electrically connects to a set of signal equipment and receives a power signal and a first control signal provided by the set of signal equipment. The magnetic circuit outputs the power signal via a first port and outputs the first control signal via a second port. The power transmission circuit converts a supplying power of the power signal into a DC device power and outputs a first power and outputs a second power to the camera according to the DC device power. The computing circuit receives the first power and an image signal generated by the camera, generates a second control signal according to the image signal, and send one of the first and second control signals to the camera.

### CROSS-REFERENCE TO RELATED APPLICATIONS

This non-provisional application claims priority under 35 U.S.C. § 119(a) on Patent Application No(s). 201910451418.7 filed in China on May 28, 2019, the entire contents of which are hereby incorporated by reference.

### BACKGROUND

### 1. Technical Field

The disclosure relates to an image processing and signal transmitting device and method thereof, and a camera lamp system, more particularly to an image processing and signal transmission device and method thereof, and a camera lamp system using a technique called Power over Ethernet (PoE).

### 2. Related Art

Under consideration of security, image monitoring systems are installed in many public buildings recently. These image monitoring systems usually do not have the functions of data analysis, object detection, event determination, and behavior recognition on the local equipment. Even if one asserts that the monitoring system provides the above functions, it actually uploads huge amounts of data to the cloud through the network, and the cloud server handles all operations, analysis, and determinations.

However, since the network speed may delay unpredictably, the implementation of the cloud-dependent computations described above may make the image monitoring system not fast enough in real-time event determination, and therefore the monitoring system cannot react immediately, resulting in loss of life and property.

### SUMMARY

According to one or more embodiment of this disclosure, an image processing and signal transmitting device adapted to a camera, comprising: an Ethernet connection port configured to electrically connect to a set of signal equipment and to receive a power signal and a first control signal provided by the set of signal equipment; a magnetic circuit electrically connected to the Ethernet connection port, wherein the magnetic circuit comprises a first port and a second port, the magnetic circuit is configured to output the power signal via the first port and to output the first control signal via the second port; and a power transmission circuit electrically connected to the first port and configured to electrically connect to the camera, wherein the power transmission circuit is configured to convert a supplying power of the power signal into a Direct Current (DC) device power, the power transmission circuit outputs a first power according to the DC device power and is configured to output a second power to the camera, wherein a voltage of the supplying power is greater than a voltage of the first power and is greater than a voltage of the second power; and a computing circuit electrically connected to the second port, the power transmission circuit, and configured to electrically connect to the camera, wherein the computing circuit is configured to receive the first power and is configured to receive an image signal generated by the camera, the computing circuit generates a second control signal according to the image signal and is configured to selectively send one of the first control signal and the second control signal to the camera.

According to one or more embodiment of this disclosure, an image processing and signal transmitting method adapted a camera, comprising: receiving a power signal and a first control signal from a set of signal equipment by an Ethernet connection port; receiving the power signal and the first control signal by a magnetic circuit electrically connected to the Ethernet connection port; outputting the power signal via a first port by the magnetic circuit and outputting the first control signal via a second port by the magnetic circuit; converting a supplying power of the power signal into a DC device power by a power transmission circuit and outputting a first power and outputting a second power according to the DC device power by the power transmission circuit, wherein a voltage of the supplying power is greater than a voltage of the first power and a voltage of the second power; and receiving the first power and an image signal generated by the camera, generating a second control according to the image signal, and selectively sending one of the first and the second control signal to the camera by a computing circuit electrically connected to the second port, the power transmission circuit and the camera.

According to one or more embodiment of this disclosure, a camera lamp system, comprising: a set of signal equipment configured to provide a first control signal and a power signal having a supplying power; an image processing and signal transmitting device electrically connected to the set of signal equipment, comprising: an Ethernet connection port configured to electrically connect to the set of signal equipment and to receive the power signal and the first control signal provided by the set of signal equipment; a magnetic circuit electrically connected to the Ethernet connection port, wherein the magnetic circuit comprises a first port and a second port, the magnetic circuit is configured to output the power signal via the first port, and to output the first control signal via the second port; and a power transmission circuit electrically connected to the first port, wherein the power transmission circuit is configured to convert the supplying power of the power signal into a Direct Current (DC) device power, and the power transmission circuit outputs a first power and a second power according to the DC device power, wherein a voltage of the supplying power is greater than a voltage of the first power and a voltage of the second power; and a computing circuit electrically connected to the second port and the power transmission circuit, wherein the computing circuit is configured to receive the first power to compute and to receive an image signal, the computing circuit generates a second control signal according to the image signal and selectively sends one of the first control signal and the second control signal; and a camera lamp module electrically connected to the power transmission circuit and the computing circuit, wherein the camera lamp module comprises at least one light-emitting element and a camera, the camera lamp module is configured to operate according to the second power, the camera is configured to generate the image signal, the camera lamp module is further configured to receive one of the first control signal and the second control signal to control the camera and the light-emitting element.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of an image processing and signal transmitting device according to an embodiment of the present disclosure;

FIG. 2 is a detailed block diagram of the image processing and signal transmitting device according to the embodiment of FIG. 1;

FIG. 3 is a flow chart of an image processing and signal transmitting method according to an embodiment of the present disclosure;

FIG. 4 is a flow chart of an image processing and signal transmission method according to another embodiment of the present disclosure; and

FIG. 5 is a block diagram of a camera lamp system according to an embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

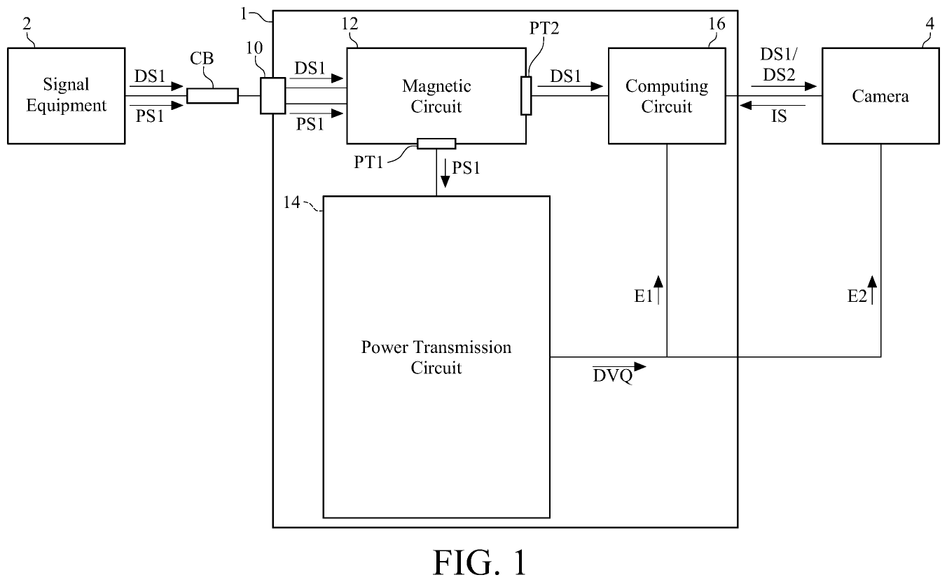

Please refer to FIG. 1, which is a block diagram of an image processing and signal transmitting device according to an embodiment of the present disclosure. As shown in FIG. 1, the image processing and signal transmitting device 1 comprises an Ethernet connection port 10, a magnetic circuit 12, a power transmission circuit 14, and a computing circuit 16.

The Ethernet connection port 10 is configured to electrically connect to a set of signal equipment 2 to receive a power signal PS1 and a first control signal DS1 provided by the set of signal equipment 2. Specifically, the Ethernet connection port 10 receives the power signal PS1 and the first control signal DS1 from the set of signal equipment 2 via an Ethernet transmission cable CB. In practical, the Ethernet connection port 10 is a RJ (registered jack) 45 connector. In an example, the set of signal equipment 2 is a power-sourcing equipment (PSE) comprising a power supply, a voltage converter (e.g. a boost converter), etc. The set of signal equipment 2 is configured to acquire power from an external power source and provide necessary power to circuits in the system or external devices by performing proper voltage transformations. However, the present disclosure is not limited to the above examples.

The magnetic circuit 12 electrically connects to the Ethernet connection port 10. The magnetic circuit 12 has a first port PT1 and a second port PT2. The magnetic circuit 12 is configured to output the power signal PS1 via the first port PT1 and the magnetic circuit 12 outputs the first control signal DS1 via the second port PT2.

The power transmission circuit 14 electrically connects to the first port PT1 and a camera 4. The power transmission circuit 14 is configured to convert a supplying power of the power signal PS1 into a DC device power DVQ, and output a first power E1 and outputs a second power E2 to the camera 4 according to the DC device power DVQ. In practical, the magnetic circuit 12 is a Magnetics Module with a type number of VP6014M. However, the present disclosure does not limit thereto.

The computing circuit 16 electrically connects to the second port PT2, the power transmission circuit 14, and is configured to electrically connect to the camera 4. The computing circuit 16 is configured to receive the first power E1 and to receive an image signal IS generated by the camera 4. The computing circuit 16 generates a second control signal DS2 according to the image signal IS and selectively sends one of the first control signal DS1 and the second control signal DS2 to the camera 4. In other words, a two-way data/signal transmission can be performed between the computing circuit 16 and the camera 4. In an example, the computing circuit 16 comprises a chip having capabilities of high-performance computation and data-processing (e.g. a CPU) adapted to control the camera 4 to perform tasks. In another example, the computing circuit 16 may be a subsystem applied with artificial intelligence (AI) edge computing. In an example, the computing circuit 16 is a CPU module of nVidia TX series installed with a neural network model, thus the computing circuit 16 may perform analysis and inference of the image signal IS. In an example, the computing circuit 16 receives the first control signal DS1 through the magnetic circuit 12 and further transmit the first control signal DS1 to the camera 4 for controlling the camera's operation. In an example, the computing circuit 16 itself may generate the second control signal DS2 according to the image signal IS, and control the lens movement of the camera 4 accordingly, thus a person detected in the image signal IS can be traced and followed. In overall, the operation of the camera 2 may be controlled by one of the set of equipment 2 and the computing circuit 16. Therefore, the image processing and signal transmitting device 1 in an embodiment of the present disclosure may react instantly according to the image signal IS, and the function of remote controlling by the control center is also preserved.

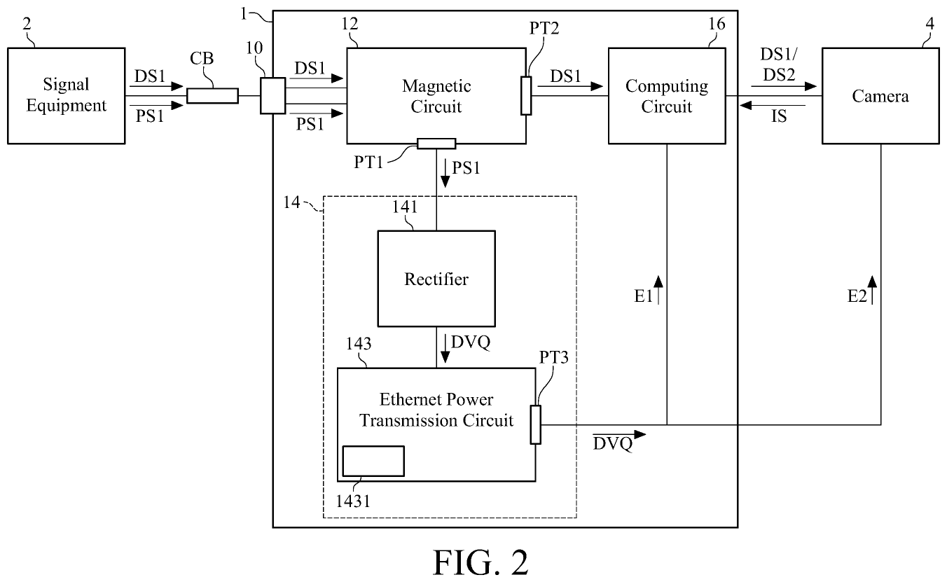

Please refer to FIG. 2, which is a detailed block diagram of the image processing and signal transmitting device 1 according to the embodiment of FIG. 1. In this embodiment, the power transmission circuit 14 comprises a rectifier 141 and an Ethernet power transmission circuit 143. The rectifier 141 electrically connects to the first port PT1 and is configured to convert the supplying power into the DC device power DVQ by performing a rectification process. Specifically, the rectifier 141 outputs the DC device power DVQ adapted to a general system or a general device by rectifying the supplying power. In an implementation, the rectifier 141 a bridge rectifier. However, the present disclosure is not limited to the above example. The Ethernet power transmission circuit 143 electrically connects to the rectifier 141 and comprises an outputting port PT3 and a transformer 1431. The transformer 1431 is configured to transform the DC device power DVQ into the first power E1 and the second power E2 by performing a buck-conversion. The Ethernet power transmission circuit 143 outputs the first power E1 and the second power E2 to the computing circuit 16 and the camera 4 respectively via the outputting port PT3.

More specifically, the Ethernet power transmission circuit 143 may assign a part of or all of the electric power (watts) of the DC device power DVQ separately to the first power E1 and the second power E2, serving as the operation power to the computing circuit 3 and the camera 4 respectively. In practice, the source of the DC device power DVQ is the supplying power whose voltage is greater than the voltage of the first power E1 and is greater than the voltage of the second power E2. For example, the supplying power from the set of signal equipment 2 is 48 volts, and both of first power E1 and the second power E2, outputted by the Ethernet power transmission circuit 143, have the voltages of 12 volts. The voltage values given in the above example are merely used for illustration. In an implementation, the actual voltage values may vary due to the computing circuit and the camera. In this embodiment, a sum of the wattages of the first power E1 and the wattages of the second power E2 is less than or equal to the wattages of the DC device power DVQ. For example, the DC device power DVQ from the set of signal equipment 2 is 30 watts, and the Ethernet power transmission circuit 143 may distribute 15 watts to the first power E1 and 12 watts to the second power E2 respectively from the electric power of the DC device power DVQ. The wattages values given above are merely used for illustration, and the present disclosure is not limited to the above example. In practice, the wattages values vary due to the types of the computing circuit 16 and the camera 4.

In an implementation, the camera 4 is a camera lamp, an IP CAM, etc. However, the present disclosure is not limited to the above example. In the image processing and signal transmitting device 1 disclosed by the present disclosure, based on the characteristics of power signal transmission and data signals transmission provided by the PoE technique, power and data can be transmitted to respective devices or systems, so that saving the use of the conventional power adapter. In other words, the image processing and signal transmitting device 1 of the present disclosure replaces the conventional DC power adapter with the Ethernet power transmission circuit and the magnetic circuit, so the present disclosure may achieve the effects of providing power and data simultaneously. Therefore, the system space can be saved and the costs for maintaining equipment is also reduced.

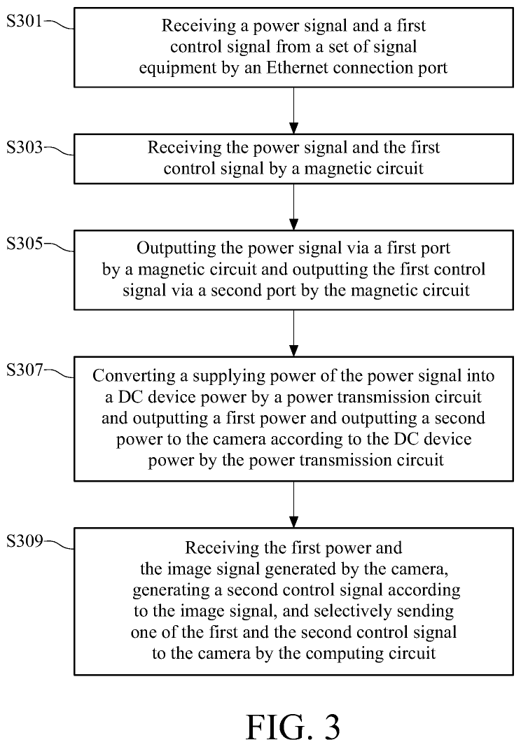

Please refer to FIG. 3, which is a flow chart of an image processing and signal transmitting method according to an embodiment of the present disclosure. The image processing and signal transmitting method can be performed by the image processing and signal transmitting device 1 shown in FIG. 1 and FIG. 2. Please refer to FIG. 3. In step S301, the power signal PS1 and the first control signal DS1 from the set of signal equipment 2 are received by the Ethernet connection port 10. In step S303, the magnetic circuit 12 receives the power signal PS1 and the first control signal DS1. In step S305, the magnetic circuit outputs the power signal PS1 via the first port PT1 and outputs the first control signal DS1 to the computing circuit 16 via the second port. In step S307, the supplying power of the power signal PS1 is converted into the DC device power DVQ by the power transmission circuit 14, and the first power E1 and the second power E2 are respectively outputted to the computing circuit 3 and the camera 4 by the power transmission circuit 14 according to the DC device power DVQ. In this embodiment, the voltage of the supplying power is greater than the voltage of the first power E1 and is greater than the voltage of the second power E2, and the first control signal DS1 is further sent from the computing circuit 16 to the camera device 4. In step S309, the computing circuit 16 receives the first power E1 and receives the image signal IS generated by the camera 4. The computing circuit 16 generates the second control signal DS2 according to the image signal and sends one of the first control signal DS1 and the second control signal DS2 to the camera 4.

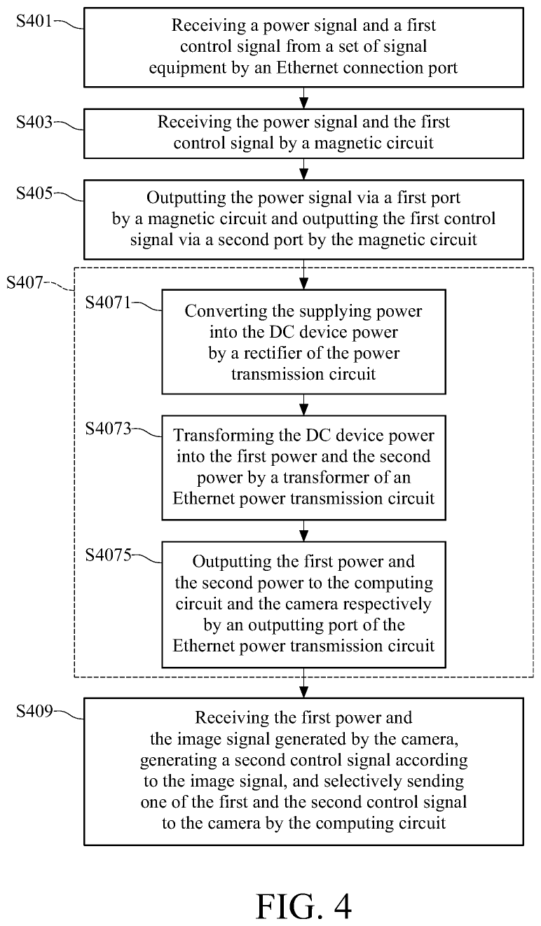

Please refer to FIG. 4, which is a flow chart of an image processing and signal transmitting method according to another embodiment of the present disclosure. Steps S401, S403, S405, and S409 shown in FIG. 4 are similar to steps S301, S303, S305, and S309 shown in FIG. 3. However, step S407 shown in FIG. 4 comprises steps S4071, S4073, and S4075. In step S4071, the supplying power is converted into the DC device power DVQ by the rectifier 141 of the power transmission circuit 14. In step S4073, the DC device power DVQ is transformed by the transformer 1431 of the Ethernet power transmission circuit 143 so that the first power E1 and the second power E2 are generated. In step S4075, the Ethernet power transmission circuit 143 respectively outputs the first power E1 and the second power E2 to the computing circuit 3 and the camera 4 via the outputting port PT3 of the Ethernet power transmission circuit 143. The image processing and signal transmitting methods shown in FIG. 3 and FIG. 4 are adapted to the image processing and signal transmitting device 1 shown in FIG. 1 and FIG. 2. Operations related to FIG. 3 and FIG. 4 can be found in the aforementioned paragraphs, so the detailed descriptions regarding the operations of FIG. 3 and FIG. 4 are not repeated here.

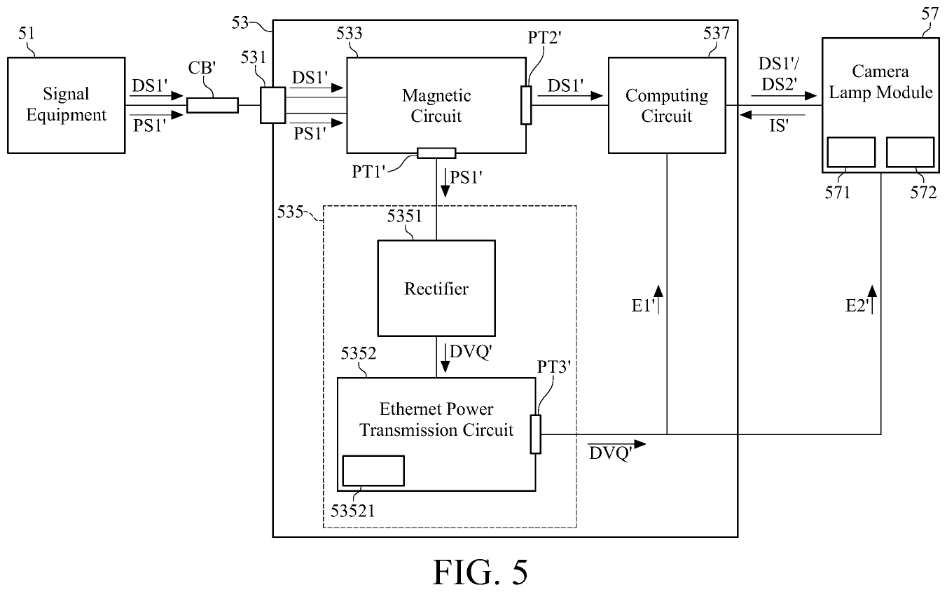

Please refer to FIG. 5, which is a block diagram of a camera lamp system 5 according to an embodiment of the present disclosure. As shown in FIG. 5, a camera lamp system 5 comprises a set of signal equipment 51, an image processing and signal transmitting device 53, and a camera lamp module 57. The set of signal equipment 51 is configured to provide a first control signal DS1′ and a power signal PS1′ having a supplying power. The image processing and signal transmitting device 53 electrically connects to the set of signal equipment 51. The image processing and signal transmitting device 53 comprises an Ethernet connection port 531, a magnetic circuit 533, a power transmission circuit 535, and a computing circuit 537. The Ethernet connection port 531 is configured to electrically connect to the set of signal equipment 51 and receive the power signal PS1′ and the first control signal DS1′ provided by the set of signal equipment 51. Specifically, the Ethernet connection port 531 electrically connects to the set of signal equipment 51 through an Ethernet transmission cable CB′. The magnetic circuit 533 electrically connects to the Ethernet connection port 531 and comprises a first port PT1′ and a second port PT2′.

The magnetic circuit 533 is configured to output a power signal PS1′ via the first port PT1′ and output a first control signal DS1′ via the second port PT2′. The power transmission circuit 535 electrically connects to the first port PT1′ and is configured to convert the supplying power of the power signal PS1′ into a DC device power DVQ′ and further output a first power E1′ and a second power E2′ according to the DC device power DVQ′. The computing circuit 537 electrically connects to the power transmission circuit 535 and the second port PT2′. The computing circuit 537 is configured to operate according to the first power E1′ and receive the first control signal DS1′. The camera lamp module 57 electrically connects to the power transmission circuit 535 and the computing circuit 537. The camera lamp module 57 comprising a light-emitting element 571 and a camera 572 is configured to operate according to the second power E2′. The camera lamp module 57 receives the first control signal DS1′ or the second control signal DS2′ from the computing circuit 537 so as to control the light-emitting element 5751 or the camera 572. In this embodiment, the operation of the image processing and signal transmitting device 53 is similar to the operation of the image processing and signal transmitting device 1 shown in FIG. 1 and FIG. 2, so the detailed descriptions about the operation of the image processing and signal transmitting device 53 are not repeated.

In an implementation, the camera lamp module 57 is a set of lamp equipment disposed on a street and including one or more light-emitting elements (e.g. LEDs) and/or a photography device (e.g. an IP CAM). A conventional camera lamp system not only needs cables for smart controls, but also needs a DC power adapter for receiving DC power. As a result, the costs for maintaining equipment remain high and the wastes of spaces for the conventional camera lamp system are inevitable. The advantages of the camera lamp system 5 disclosed in the present disclosure lies in that a signal transmission device 53, substituting the conventional DC power adapter, is applied to achieve the purpose of transmitting power and data concurrently, and accordingly the cost for maintaining equipment and the wastes of spaces are reduced.

In an embodiment, the power transmission circuit 535 comprises a rectifier 5351 and an Ethernet power transmission circuit 5352. The rectifier 5351 electrically connects to the first port PT1′. The rectifier 5351 is configured to convert the supplying power into a DC device power DVQ′ by performing a rectification conversion. The Ethernet power transmission circuit 5352 electrically connects to the rectifier 5351. The Ethernet power transmission circuit 5352 comprises an outputting port PT3′ and a transformer 53521. The transformer 53521 is configured to transform the DC device power DVQ′ into the first power E1′ and the second power E2′ by performing a buck-conversion. The Ethernet power transmission circuit 5352 respectively outputs the first power E1′ and the second power E2′ to the computing circuit 537 and the camera lamp module 57 via the outputting port PT3′. The computing circuit 537 performs image processing operations according to the image signal IS received from the camera lamp module 57, and further sends the first control signal DS1′ or the second control signal DS2′ to the camera lamp module 57 selectively.

In summary, the present disclosure proposes an image processing and signal transmitting device, an image processing and signal transmitting method, and a camera lamp system. Since the Ethernet can transmit power and signals, the camera may thus be powered and the control signals for controlling the camera may also be transmitted. The present disclosure eliminates the need for traditional power adapters, reduces maintenance costs, and avoids waste of installation space, thereby significantly improving defects of traditional monitoring systems. In terms of image processing, based on the concept of edge computing, the present disclosure may directly process the captured image to instantly drive the existing monitoring system to react. Meanwhile, the present disclosure still accepts the control signal transmitted from the cloud server through the Ethernet. The existing monitoring system can also externally attach the image processing and signal transmitting device or the camera lamp system proposed by the present disclosure, thereby extending the life cycle of the existing monitoring system without eliminating the old monitoring system and purchasing another new monitoring system.

What is claimed is:

1. An image processing and signal transmitting device adapted to a camera, comprising:
an Ethernet connection port configured to electrically connect to a set of signal equipment and to receive a power signal and a first control signal provided by the set of signal equipment;
a magnetic circuit electrically connected to the Ethernet connection port, wherein the magnetic circuit comprises a first port and a second port, the magnetic circuit is configured to output the power signal via the first port and to output the first control signal via the second port; and
a power transmission circuit electrically connected to the first port and configured to electrically connect to the camera, wherein the power transmission circuit is configured to convert a supplying power of the power signal into a Direct Current (DC) device power, the power transmission circuit outputs a first power according to the DC device power and is configured to output a second power to the camera, wherein a voltage of the supplying power is greater than a voltage of the first power and is greater than a voltage of the second power; and
a computing circuit electrically connected to the second port, the power transmission circuit, and configured to electrically connect to the camera, wherein the computing circuit is configured to receive the first power and is configured to receive an image signal generated by the camera, the computing circuit generates a second control signal according to the image signal and is configured to selectively send one of the first control signal and the second control signal to the camera.

2. The image processing and signal transmitting device according to claim 1, wherein the power transmission circuit comprises:
a rectifier electrically connected to the first port and configured to convert the supplying power into the DC device power; and
an Ethernet power transmission circuit electrically connected to the rectifier, wherein the Ethernet power transmission circuit comprises an outputting port and a transformer, the transformer is configured to transform the DC device power into the first power and the second power, and the Ethernet power transmission circuit is configured to output the first power and the second power to the computing circuit and the camera respectively via the outputting port.

3. An image processing and signal transmitting method adapted a camera, comprising:
receiving a power signal and a first control signal from a set of signal equipment by an Ethernet connection port;
receiving the power signal and the first control signal by a magnetic circuit electrically connected to the Ethernet connection port;
outputting the power signal via a first port by the magnetic circuit and outputting the first control signal via a second port by the magnetic circuit;
converting a supplying power of the power signal into a DC device power by a power transmission circuit and outputting a first power and outputting a second power according to the DC device power by the power transmission circuit, wherein a voltage of the supplying power is greater than a voltage of the first power and a voltage of the second power; and
receiving the first power and an image signal generated by the camera, generating a second control according to the image signal, and selectively sending one of the first and the second control signal to the camera by a computing circuit electrically connected to the second port, the power transmission circuit, and the camera.

4. The signal transmitting method according to claim 3, wherein converting the supplying power of the power signal into the DC device power by the power transmission circuit and outputting the first power and outputting the second power to the computing circuit respectively comprising:
converting the supplying power into the DC device power by a rectifier of the power transmission circuit;
transforming the DC device power into the first power and the second power by a transformer of an Ethernet power transmission circuit; and
outputting the first power and the second power to the computing circuit and the camera respectively by an outputting port of the Ethernet power transmission circuit.

5. A camera lamp system, comprising:
a set of signal equipment configured to provide a first control signal and a power signal having a supplying power;
an image processing and signal transmitting device electrically connected to the set of signal equipment, comprising:
an Ethernet connection port configured to electrically connect to the set of signal equipment and to receive the power signal and the first control signal provided by the set of signal equipment;
a magnetic circuit electrically connected to the Ethernet connection port, wherein the magnetic circuit comprises a first port and a second port, the magnetic circuit is configured to output the power signal via the first port, and to output the first control signal via the second port; and
a power transmission circuit electrically connected to the first port, wherein the power transmission circuit is configured to convert the supplying power of the power signal into a Direct Current (DC) device power, and the power transmission circuit outputs a first power and a second power according to the DC device power, wherein a voltage of the supplying power is greater than a voltage of the first power and a voltage of the second power; and
a computing circuit electrically connected to the second port and the power transmission circuit, wherein the computing circuit is configured to receive the first power to compute and to receive an image signal, the computing circuit generates a second control signal according to the image signal and selectively sends one of the first control signal and the second control signal; and
a camera lamp module electrically connected to the power transmission circuit and the computing circuit, wherein the camera lamp module comprises at least one light-emitting element and a camera, the camera lamp module is configured to operate according to the second power, the camera is configured to generate the image signal, the camera lamp module is further configured to receive one of the first control signal and the second control signal to control the camera and the light-emitting element.

6. The camera lamp system according to claim 5, wherein the power transmission circuit comprises:
a rectifier electrically connected to the first port and configured to convert the supplying power into the DC device power; and
an Ethernet power transmission circuit electrically connected to the rectifier, wherein the Ethernet power transmission circuit comprises an outputting port and a transformer, the transformer is configured to transform the DC device power into the first power and the second power, and the Ethernet power transmission circuit is configured to output the first power and the second power to the computing circuit and the camera lamp module respectively via the outputting port.
